(19) United States
(12) Patent Application Publication
(10) Pub. No.: US 2024/0375397 A1
(43) Pub. Date: Nov. 14, 2024

(54) LIQUID EJECTION HEAD AND LIQUID EJECTION APPARATUS

(71) Applicant: CANON KABUSHIKI KAISHA, Tokyo (JP)

(72) Inventors: RYO SATO, Tokyo (JP); TAKEHO MIYASHITA, Kanagawa (JP); KYOSUKE TODA, Kanagawa (JP); YUJI TAMARU, Tokyo (JP); SHIMPEI YOSHIKAWA, Kanagawa (JP); CHIAKI MURAOKA, Saitama (JP)

(21) Appl. No.: 18/659,471

(22) Filed: May 9, 2024

(30) Foreign Application Priority Data
May 11, 2023 (JP) 2023-078597

(51) Int. Cl. B41J 2/14; B41J 2/045

(52) U.S. Cl. CPC B41J 2/14; B41J 2/04563; B41J 2202/03

(57) ABSTRACT

Provided is a liquid ejection head with a simple structure capable of keeping a desired temperature of a liquid after the liquid is adjusted to the desired temperature. The liquid ejection head includes: an ejection module including an ejection port, a pressure chamber, a supply channel, an energy generator element, and a collection channel; and a support member joined to the ejection module and configured to support the ejection module. The liquid flowing in the pressure chamber, the supply channel, and the collection channel is adjusted to a predetermined temperature by a temperature adjustment mechanism. A material for making the support member has a thermal conductivity of 1.0 (W/m·K) or lower.

### FIELD OF THE DISCLOSURE

The present disclosure relates to a liquid ejection head and a liquid ejection apparatus.

### DESCRIPTION OF THE RELATED ART

In a liquid ejection apparatus capable of performing printing by ejecting ink, the viscosity of the ink near ejection ports of the liquid ejection head may increase due to evaporation of volatile components in the ink from the ejection ports. An increase in the viscosity of the ink may influence the ejection characteristics of the liquid ejection head. In one of known methods for suppressing an increase in the viscosity of ink, ink to be supplied to the liquid ejection head is circulated in a circulation path.

Japanese Patent Laid-Open No. 2016-140992 describes an inkjet head (liquid ejection head) to which an ink circulation system can be connected.

Some liquid ejection head is equipped with a temperature adjustment mechanism for adjusting a liquid to be used for printing to a target temperature, thereby making the viscosity appropriate.

However, Japanese Patent Laid-Open No. 2016-140992 does not disclose means for keeping the temperature of the liquid to be used for printing after the liquid is adjusted to the desired temperature. In addition, the inkjet head in Japanese Patent Laid-Open No. 2016-140992 includes a ceramic board. The ceramics has a relatively high thermal conductivity. For this reason, in the case of the inkjet head in Japanese Patent Laid-Open No. 2016-140992, even if the liquid is adjusted to the desired temperature, it is difficult to keep the adjusted temperature because the heat dissipates from the board.

### SUMMARY

Accordingly, an object of the present invention is to provide a liquid ejection head with a simple structure capable of keeping a desired temperature of a liquid after the liquid is adjusted to the desired temperature.

A liquid ejection head of the present disclosure has an ejection module including: an ejection port capable of ejecting a liquid, a pressure chamber capable of storing the liquid to be ejected from the ejection port, a supply channel configured to supply the liquid to the pressure chamber, an energy generator element capable of generating energy for ejecting the liquid stored in the pressure chamber, and a collection channel configured to collect, to the pressure chamber, the liquid not ejected from the ejection port; and a support member joined to the ejection module and configured to support the ejection module, wherein the liquid flowing in the pressure chamber, the supply channel, and the collection channel is adjusted to a predetermined temperature by a temperature adjustment mechanism, and a material for making the support member has a thermal conductivity of 1.0 (W/m·K) or lower.

Further features of the present disclosure will become apparent from the following description of exemplary embodiments with reference to the attached drawings.

### BRIEF DESCRIPTION OF THE DRAWINGS

FIG. 1 is an external appearance perspective view illustrating an example of a liquid ejection apparatus in an embodiment;

FIG. 2 is a schematic exploded perspective view of a liquid ejection head in the embodiment;

FIG. 3 is a perspective view of a state where the components illustrated in FIG. 2 are assembled;

FIG. 4 is a view seen in an arrow direction A in FIG. 3;

FIG. 5 is an external appearance schematic view illustrating an example of a circulation unit in the embodiment;

FIG. 6 is a schematic view illustrating a liquid circulation path in the embodiment;

FIG. 7 is an exploded perspective view of an ejection module unit in the embodiment seen from above;

FIG. 8 is an exploded perspective view of an ejection module in the embodiment seen from below;

FIG. 9 is a schematic plan view of an aperture plate in the embodiment;

FIG. 10 is a schematic plan view of a print element board in the embodiment;

FIG. 11 is a schematic cross-sectional view of the ejection module unit in the embodiment;

FIG. 12 is a schematic cross-sectional view of the ejection module unit in the embodiment; and

FIG. 13 is a schematic cross-sectional view of the ejection module unit in the embodiment.

### DESCRIPTION OF THE EMBODIMENTS

Hereinafter, examples of embodiments of the present disclosure will be described in reference to the drawings. It should be noted that the following description is not intended to limit the scope of the present disclosure.

### <Description of Liquid Ejection Apparatus>

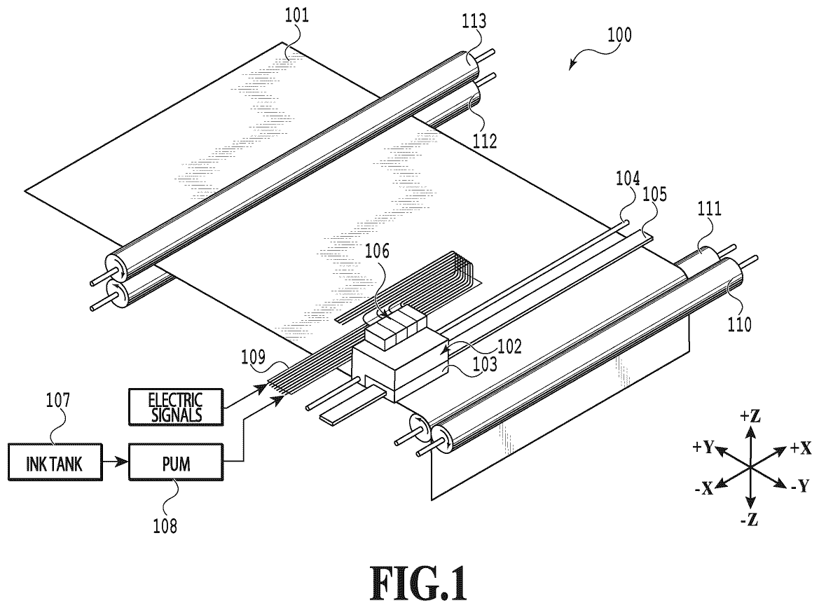

FIG. 1 is an external appearance perspective view illustrating an example of a liquid ejection apparatus 100 usable in a present embodiment.

The coordinate axes in the drawings will be explained herein. In the drawings to be referred to in the present specification, an X direction and a Y direction denote two directions orthogonal to each other on a horizontal plane. AZ direction denotes a vertical direction. A+Y direction points to the front, a −Y direction points to the rear, a −X direction points to the left, a +X direction points to the right, a +Z direction points to the upper side, and a-Z direction points to the lower side of the liquid ejection apparatus 100. The +Y direction points to a downstream in a conveyance direction of a printing medium 101 and the −Y direction points to an upstream in the conveyance direction of the printing medium 101. The X direction may be referred to as a main-scanning direction and the Y direction may be referred to as a sub-scanning direction as needed. In the following description, the upper, lower, right, and left indicate the directions of the liquid ejection apparatus 100 in a posture for use in which the liquid ejection apparatus 100 is used in a normal condition unless otherwise specified.

The present embodiment will be described based on the assumption that a “liquid” is an ink. However, the liquid usable in the present embodiment is not limited to the ink. More specifically, as the liquid, any of various printing solutions may be used including treatment liquids for the purposes of improving the fixing property, reducing the glossy unevenness, or improving the rubfastness of the ink on the printing medium 101.

The “printing medium” refers to not only a usual paper sheet usable in liquid ejection apparatuses but also any medium which can accept a liquid such as cloth, plastic film, metallic plate, glass, ceramics, resin, wood, or leather.

The “printing” (also referred to as “recording”) means not only forming information having some meaning such as characters and graphics, but also forming information having no meaning such as an image, a texture, or a pattern. Moreover, it does not matter whether what is formed by “printing” can be visually perceived by humans. In other words, the “printing” also means forming a structure on the printing medium 101 or processing the medium.

As illustrated in FIG. 1, the liquid ejection apparatus 100 includes a liquid ejection head 102 capable of performing printing by ejecting inks. The liquid ejection head 102 is mounted on a carriage 103 that can reciprocate in the main-scanning direction (the +X directions). The carriage 103 is supported by a guide shaft 104 extending in the main-scanning direction so that the carriage 103 can slide along the guide shaft 104. The carriage 103 is fixed to an endless belt 105 arranged in parallel with the guide shaft 104.

In the state where the carriage 103 is fixed to the endless belt 105, an ejection port surface of the liquid ejection head 102 in which ejection ports for ejecting the inks are formed is held in a state facing and being parallel with a platen (not illustrated) which supports the printing medium 101 from the −Z direction. The endless belt 105 is moved in the leftward direction (the −X direction) and the rightward direction (the +X direction) with rotations of a driving pulley (not illustrated) driven by a carriage motor (not illustrated). With movements of the endless belt 105 in the main-scanning direction, the carriage 103 also reciprocates in the main-scanning direction along the guide shaft 104.

In the present embodiment, the liquid ejection head 102 is equipped with one or more circulation units 106 (four in the present example) capable of circulating the inks thereinside. Here, a cover for covering the circulation units 106 is attached in reality. However, for convenience of description, the cover is not illustrated.

To the liquid ejection head 102, electrical wiring lines for sending electric signals necessary for printing, tubes for supplying the inks from an ink tank 107 via a pump 108, and pipes for supplying the air are connected. These electrical wiring lines, tubes, and pipes are guided to the liquid ejection head 102 along a guide 109.

In the present embodiment, the four circulation units 106 are respectively and individually supplied with four color inks of CMYK (cyan color, magenta color, yellow color, and black color). The liquid ejection head 102 is capable of performing full-color printing using these four color inks. The colors of the inks applicable to the present embodiment are not limited to these four colors. The colors of the inks may be three or less to five or more colors including a color other than the above four colors.

The liquid ejection apparatus 100 includes a first conveyance roller 110, a second conveyance roller 111, a third conveyance roller 112, and a fourth conveyance roller 113 driven by conveyance motors (not illustrated). Each of the conveyance motors for respectively driving these conveyance rollers can rotate in forward and reverse directions. The first conveyance roller 110 and the second conveyance roller 111 can hold the printing medium 101 in between on an upstream side of the carriage 103 (the −Y direction side) in the conveyance direction. The third conveyance roller 112 and the fourth conveyance roller 113 can hold the printing medium 101 in between on a downstream side of the carriage 103 (the +Y direction side) in the conveyance direction.

In the present embodiment, the conveyance direction is defined as the direction (the +Y direction) orthogonal to the main-scanning direction. As illustrated by arrows in FIG. 1, as the liquid ejection apparatus 100 is viewed from the right side (the −X direction side), the first conveyance roller 110 rotates clockwise while the second conveyance roller 111 rotates counterclockwise. The third conveyance roller 112 rotates counterclockwise while the fourth conveyance roller 113 rotates clockwise. With the rotations of these conveyance rollers, the printing medium 101 is conveyed in the conveyance direction (the +Y direction) crossing (orthogonal to in the present example) the main-scanning direction. The liquid ejection apparatus 100 prints an image by ejecting the inks while reciprocating the liquid ejection head 102 in the main-scanning direction and intermittently transporting the printing medium 101 to the downstream side (the +Y direction side) in the conveyance direction. Such an operation of the liquid ejection head 102 will be referred to as a “printing operation” below. Thus, the liquid ejection apparatus 100 in the present embodiment is a so-called serial type of inkjet printer. In the present embodiment, the liquid ejection head 102 includes temperature adjustment mechanisms (to be described later) capable of adjusting the inks to a temperature appropriate for ink ejection. The printing operation is started after the inks reach the desired temperature. Thus, the viscosity of the inks is kept adequate during the printing operation.

The liquid ejection apparatus 100 is also provided with a recovery mechanism (not illustrated) for maintaining and recovering the ejection performance of the ejection ports. This recovery mechanism is arranged in a non-printing area provided near a scanning standard position (home position) in the liquid ejection head 102. This recovery mechanism includes a cap (not illustrated) for closing the ejection ports, a wiper (not illustrated) for wiping off the excess inks and the like attached to the ejection port surface where the ejection ports are formed, and so on. At a non-printing time, the cap is relatively moved to the position for covering the ejection ports. Then, the recovery mechanism performs an operation such as suppressing drying on the ejection ports, filling the inks, or sucking the inks for recovering the ejection performance.

### <Description of Structure of Liquid Ejection Head>

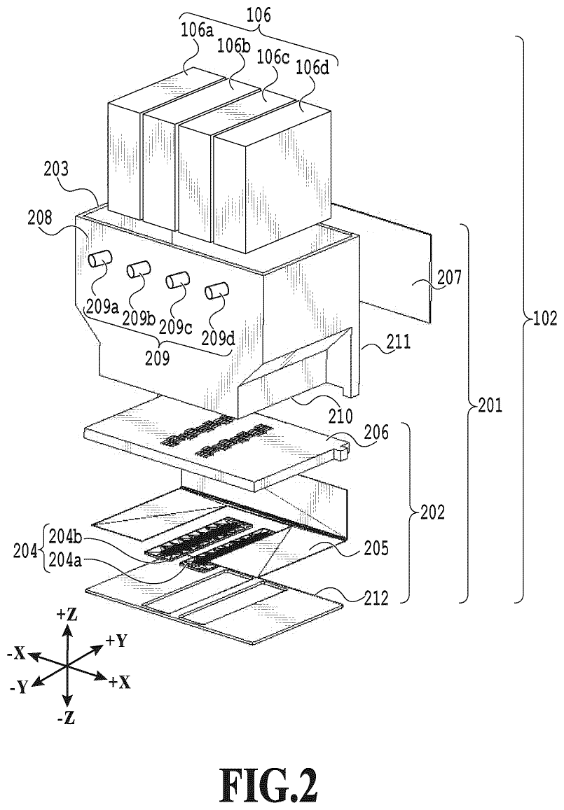

FIG. 2 is an exploded perspective view of the liquid ejection head 102 in the present embodiment.

As illustrated in FIG. 2, the liquid ejection head 102 includes an ejection unit 201 for ejecting the inks and the circulation units 106 for circulating the inks. The ejection unit 201 includes an ejection module unit 202 in which multiple members are stacked, and a casing 203 capable of accommodating the circulation units 106.

The ejection module unit 202 includes an ejection module 204 having the ejection ports, a connection board 205 arranged over the lower surface and the back surface of the liquid ejection head 102, a support member 206 capable of supporting the connection board 205, and an electric board 207 which can be electrically connected to the connection board 205. The ejection module unit 202 also includes a face cover 212 capable of covering the lower surface of the connection board 205 (the side facing in the −Z direction).

The ejection module 204 includes a first ejection module 204a and a second ejection module 204b which are joined to the lower surface of the support member 206. The first ejection module 204a and the second ejection module 204b will be simply referred to as the ejection module 204 below unless they have to be distinguished from each other. Here, the ejection module 204 is not covered with the face cover 212.

The circulation units 106 include a first circulation unit 106a, a second circulation unit 106b, a third circulation unit 106c, and a fourth circulation unit 106d respectively corresponding to the cyan color, the magenta color, the yellow color, and the black color.

The first circulation unit 106a, the second circulation unit 106b, the third circulation unit 106c, and the fourth circulation unit 106d will be simply referred to as the circulation unit 106 below unless they have to be distinguished from each other. The circulation unit 106 is fixed to the casing 203 by inserting a sealing member between the circulation unit 106 and the casing 203 and then fastening them with screws. Instead, the circulation unit 106 may be welded to the casing 203.

The casing 203 has a connection surface 208 facing in a direction in which the inks are received from an apparatus main body. In the connection surface 208, formed are a first connection portion 209a, a second connection portion 209b, a third connection portion 209c, and a fourth connection portion 209d to which the tubes guided along the guide 109 (see FIG. 1) are to be connected. The tube for supplying the cyan color ink is connected to the first connection portion 209a. The tube for supplying the magenta color ink is connected to the second connection portion 209b. The tube for supplying the yellow color ink is connected to the third connection portion 209c. The tube for supplying the black color ink is connected to the fourth connection portion 209d. The first connection portion 209a is linked to the first circulation unit 106a. The second connection portion 209b is linked to the second circulation unit 106b. The third connection portion 209c is linked to the third circulation unit 106c. The fourth connection portion 209d is linked to the fourth circulation unit 106d. The first connection portion 209a, the second connection portion 209b, the third connection portion 209c, and the fourth connection portion 209d will be simply referred to as the connection portion 209 below unless they have to be distinguished from each other. Thus, the inks supplied via the tubes from the ink tank are supplied to the circulation unit 106 via the connection portion 209.

The support member 206 capable of supporting the first ejection module 204a and the second ejection module 204b is joined to a bottom portion 210 of the casing 203. The inks supplied to the circulation unit 106 flow through channels formed in the bottom portion 210 and are supplied to apertures formed to penetrate the support member 206 in the vertical direction (the Z direction). One example of methods for joining the upper surface of the support member 206 to the lower surface of the casing 203 is, for example, to bond them by using an adhesive agent. Another example of the methods for joining the upper surface of the support member 206 to the lower surface of the casing 203 is, for example, to fix the support member 206 to the casing 203 by inserting a seal member between the upper surface of the support member 206 and the lower surface of the casing 203 and then fastening them with screws.

The casing 203 has a contact surface 211 facing in a direction (the +Y direction) opposite to the direction (the −Y direction) in which the connection surface 208 faces. On the contact surface 211, the electric board 207 is provided. The upper surface of the connection board 205 (the surface facing in the +Z direction) is joined to the lower surface of the support member 206 (the surface facing in the −Z direction).

The upper surface of the face cover 212 (the surface facing in the +Z direction) is joined to the lower surface of the connection board 205 (the surface facing in the −Z direction). The upper surface of the face cover 212 is bonded to the lower surface of the connection board 205 with an adhesive agent. Instead, the face cover 212 may be fixed to the support member 206 in a mechanical method such as screw fastening. The face cover 212 can protect the ejection port surface from wiper rubbing during wiping, paper rubbing during printing operations, and the like. The presence of the face cover 212 makes it possible to improve the flatness of the lower surface of the liquid ejection head 102 (the surface facing in the −Z direction) as compared with the lower surface of a liquid ejection head without the face cover 212. This also improves the reliability of capping in the case where the cap of the recovery mechanism covers the lower surface of the liquid ejection head 102.

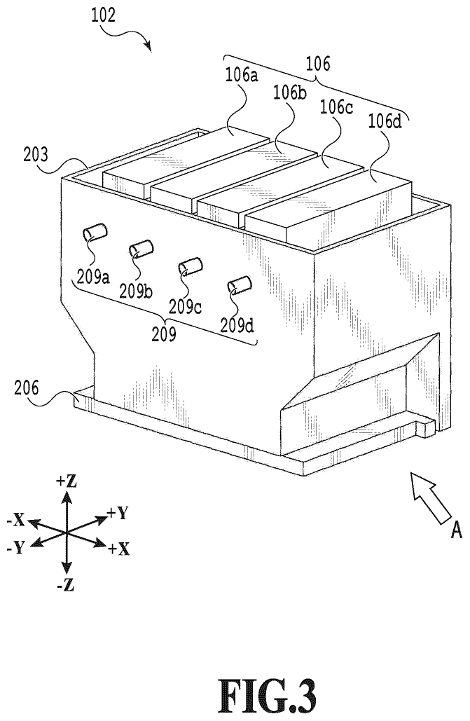

FIG. 3 is a perspective view of a state where the components illustrated in FIG. 2 are assembled. In FIG. 3, the face cover is not illustrated for convenience of description.

As illustrated in FIG. 3, the support member 206 supports the casing 203 in the state where the upper surface of the support member 206 is bonded to the lower surface of the casing 203. In the state where the circulation unit 106 is accommodated in the casing 203, channels continuous from the connection portion 209 to the ejection ports are formed in the liquid ejection head 102.

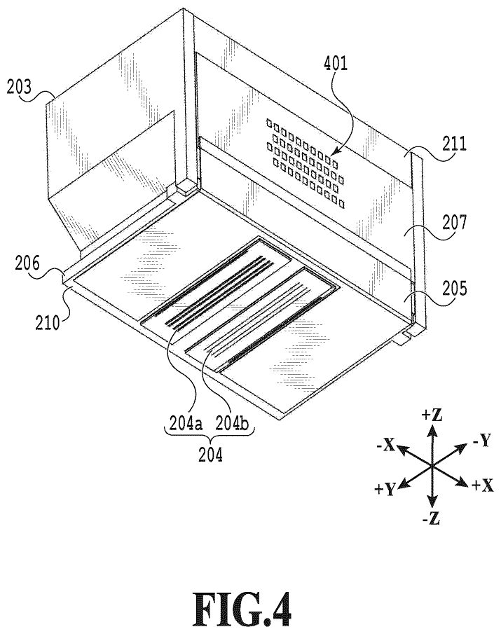

FIG. 4 is a view seen in an arrow direction A in FIG. 3. In FIG. 4, the face cover is not illustrated for convenience of description.

As illustrated in FIG. 4, terminals 401 for receiving electric signals sent from the apparatus main body are arranged in the electric board 207. The electric board 207 is fixed to the casing 203 by caulking. The electric board 207 may be bonded to the contact surface 211 with an adhesive agent or a double-sided tape. On the contact surface 211, terminals (not illustrated) of the electric board 207 and terminals (not illustrated) of the connection board 205 are connected to each other by wire bonding. The terminals (not illustrated) of the electric board 207 and the terminals (not illustrated) of the connection board 205 may be pressure-bonded using an anisotropic conductive film (ACF).

On the bottom portion 210, terminals (not illustrated) of the connection board 205 and terminals (not illustrated) of the ejection module 204 are connected to each other by wire bonding. The terminals (not illustrated) of the connection board 205 and the terminals (not illustrated) of the ejection module 204 may be connected to each other by flying lead bonding.

With this structure, the electric signals sent from the apparatus main body to the terminals 401 are sent to the ejection module 204 via the electric board 207 and the connection board 205. According to the electric signals, the inks are ejected from the ejection module 204. In the present embodiment, the cyan color ink is ejected from a first ejection port array and the magenta color ink is ejected from a second ejection port array, which arrays are formed in the first ejection module 204a. Meanwhile, the yellow color ink is ejected from a third ejection port array and the black color ink is ejected from a fourth ejection port array, which arrays are formed in the second ejection module 204b.

### <Description of Circulation Path>

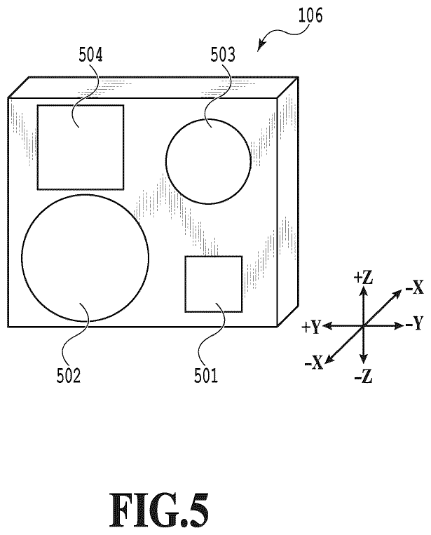

FIG. 5 is an external appearance schematic view of the circulation unit 106 applied to the liquid ejection apparatus in the present embodiment. Although the circulation unit 106 includes the first, second, third, and fourth circulation units, only one circulation unit will be described as an example with reference to FIG. 5 for convenience of description. The structures of the first, second, third, and fourth circulation units are the same entirely except for the colors of the inks to be circulated.

As illustrated in FIG. 5, the circulation unit 106 includes a filter 501, a first pressure control mechanism 502 and a second pressure control mechanism 503 as a pressure control unit, and a circulator pump 504 for circulating the ink. The circulator pump 504 in the present embodiment is a piezoelectric diaphragm pump that changes the volume inside a pump chamber by inputting a drive voltage to a piezoelectric element attached to a diaphragm, and thereby pumps a liquid by alternately operating two check valves with pressure changes.

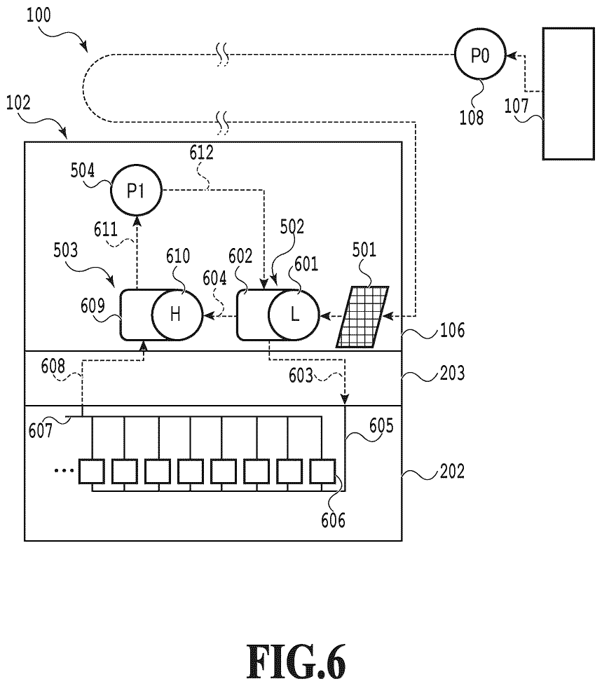

FIG. 6 is a schematic view of an ink circulation path inside the liquid ejection head 102. In the present embodiment, there are four circulation paths. For convenience of description, only one of the four circulation paths will be described as an example with reference to FIG. 6. The structures of these four circulation paths are the same entirely except for the colors of the inks to be circulated.

As illustrated in FIG. 6, the circulation path capable of circulating the ink is provided inside the liquid ejection head 102. This circulation path circulates the ink between a first valve chamber 601 and the ejection module unit 202.

In the present embodiment, the total volume of the circulation path formed inside the liquid ejection head 102 is about 10 mL. The “circulation path” in the present embodiment means a path extending from the first valve chamber 601 to the ejection module unit 202, passing through the second valve chamber 610 and the circulator pump 504, and returning to the first valve chamber 601 again.

The first pressure control mechanism 502 includes the first valve chamber 601 having a first valve (not illustrated) and a first pressure control chamber 602 formed to communicate with the first valve chamber 601 via the first valve. The first pressure control mechanism 502 and the second pressure control mechanism 503 are connected to each other via a bypass channel 604.

The second pressure control mechanism 503 includes the second valve chamber 610 having a second valve (not illustrated) and a second pressure control chamber 609 formed to communicate with the second valve chamber 610 via the second valve.

Inside the circulation unit 106, provided are a pump inlet channel 611 formed to connect the second pressure control chamber 609 to the circulator pump 504 and a pump outlet channel 612 formed to connect the circulator pump 504 to the first pressure control chamber 602.

On the bottom portion of the casing 203, provided are a first supply channel 603 formed to connect the first pressure control chamber 602 to the ejection module unit 202 and a second collection channel 608 formed to connect the ejection module unit 202 to the second pressure control chamber 609.

In the ejection module unit 202, provided are a second supply channel 605 formed to connect the first supply channel 603 to multiple pressure chambers 606 and a first collection channel 607 formed to connect the multiple pressure chambers 606 to the second collection channel 608.

### <Ink Circulation>

With driving by the pump 108, the ink is supplied by pressure to the first valve chamber 601 from the ink tank 107 through the filter 501. After that, the pressure of the ink flowing to the first pressure control chamber 602 through the first valve is controlled in the first valve chamber 601.

On the other hand, the circulator pump 504 drives to pump the ink from the pump inlet channel 611 arranged upstream of the circulator pump 504 into the pump outlet channel 612 arranged downstream of the circulator pump 504. With driving by the circulator pump 504, the pressure inside the first pressure control chamber 602 is controlled and the ink is supplied to the first supply channel 603 and the bypass channel 604. The ink supplied to the first supply channel 603 is supplied to the multiple pressure chambers 606 through the second supply channel 605. The ink supplied to the bypass channel 604 is supplied to the second valve chamber 610.

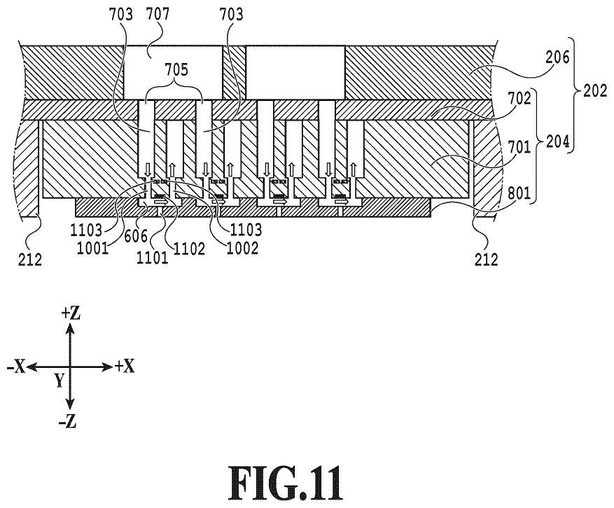

Each of the pressure chambers 606 is provided with an ejection port 1101 for ejecting the ink and a heater resistor element 1102 for generating ejection energy (see FIG. 11). The ink supplied to the pressure chamber 606 but not ejected from the ejection port is collected to the second pressure control chamber 609 through the first collection channel 607 and the second collection channel 608 formed to connect to the first collection channel 607. In the second pressure control chamber 609, the pressure is controlled so that the ink can flow into the second valve chamber 610. With the pressure controlled in the second pressure control chamber 609, the ink flows into the second valve chamber 610 via the second valve.

In the second valve chamber 610, the pressure is controlled so that the ink can return to the second pressure control chamber 609. With the pressure controlled in the second valve chamber 610, the ink returns to the second pressure control chamber 609 via the second valve.

The ink returned to the second pressure control chamber 609 from the second valve chamber 610 is collected to the circulator pump 504 via the pump inlet channel 611. The ink collected in the circulator pump 504 is again supplied to the first pressure control chamber 602 via the pump outlet channel 612.

The above is the description of the circulation path in the present embodiment.

### <Description of Ejection Module Unit 202>

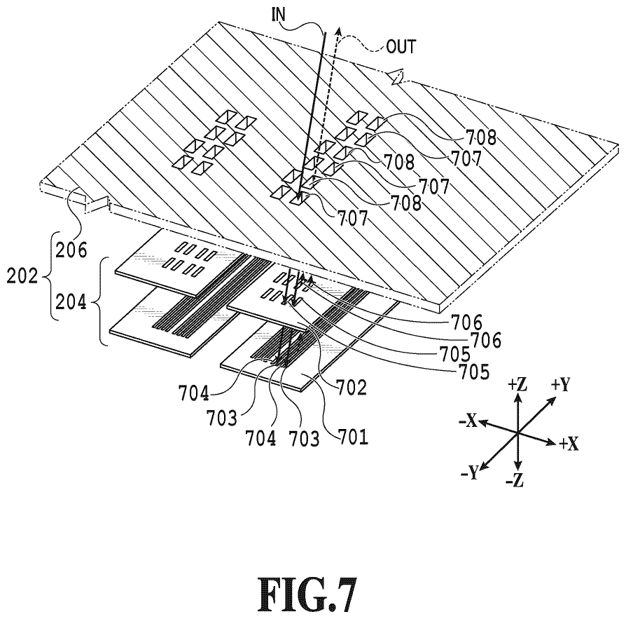

FIG. 7 is an exploded perspective view of the ejection module unit 202 in the present embodiment seen from above. In FIG. 7, the connection board and the electric board are not illustrated for ease of understanding. In FIG. 7, solid line arrows indicate flows of the ink supplied from the support member 206 to the ejection module 204. On the other hand, in FIG. 7, broken line arrows indicate flows of the ink collected from the ejection module 204 to the support member 206.

As illustrated in FIG. 7, the ejection module unit 202 includes two ejection modules 204 and one support member 206. One ejection module 204 includes one print element board 701 and one aperture plate 702. A material for making the aperture plate 702 may be silicon or resin.

On the upper surface of the print element board 701 (the surface facing in the +Z direction in FIG. 7), multiple common supply channels 703 and multiple common collection channels 704 are formed to extend along the longitudinal direction (the Y direction in FIG. 7) of the print element board 701. The print element board 701 has a thickness (a length in the X direction in FIG. 7) of 0.5 to 1 mm.

In the lower surface of the print element board 701 (the surface facing in the −Z direction in FIG. 7), supply ports for supplying the ink from the common supply channels 703 to the pressure chambers and collection ports for collecting the ink from the pressure chambers to the common collection channels 704 are formed. In the present specification, “supply” and “collection” respectively mean supply and collection in ink circulation in the forward direction.

The print element board 701 is made of silicon. On the print element board 701, electric wiring lines for supplying power to the respective multiple heater resistor elements are formed by a film deposition technique. One ejection port forming member (to be described later) in which multiple ejection ports are formed is joined to one print element board 701.

The aperture plate 702 includes multiple plate supply ports 705 for supplying the ink to the print element board 701 and multiple plate collection ports 706 for collecting the ink from the print element board 701. The plate supply ports 705 and the plate collection ports 706 are formed to pass through the aperture plate 702 in a gravitational direction (the Z direction in FIG. 7). One plate supply port 705 is capable of supplying the ink to one of the common supply channels 703. One plate collection port 706 is capable of collecting the ink from one of the common collection channels 704.

One support member 206 includes multiple support member supply ports 707 for supplying the ink to the two aperture plates 702 and multiple support member collection ports 708 for collecting the ink from the two aperture plates 702. The support member supply ports 707 and the support member collection ports 708 are formed to pass through the support member 206 in the gravitational direction (the Z direction in FIG. 7). One support member supply port 707 is capable of supplying the ink to two of the plate supply ports 705. One support member collection port 708 is capable of collecting the ink from two of the plate collection ports 706.

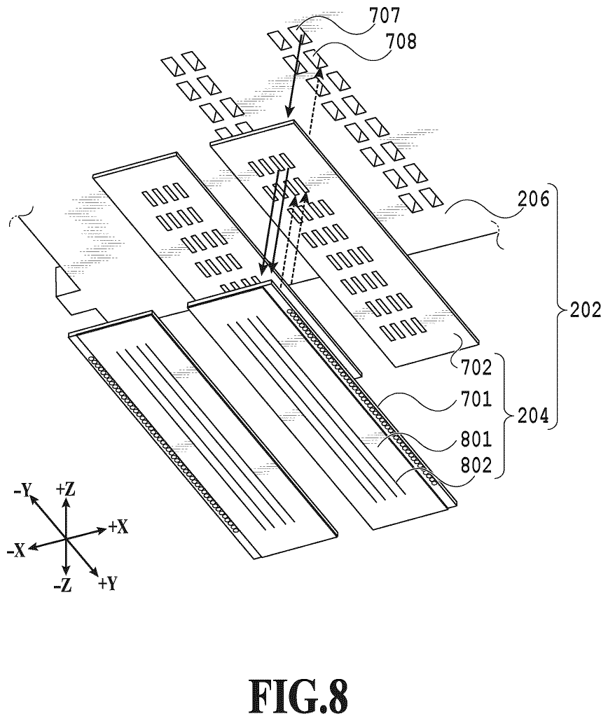

FIG. 8 is an exploded perspective view of the ejection module unit 202 in the present embodiment seen from below. In FIG. 8, solid line arrows indicate flows of the ink supplied from the support member 206 to the ejection module 204. On the other hand, in FIG. 8, broken line arrows indicates flows of the ink collected from the ejection module 204 to the support member 206. Also in FIG. 8, the connection board and the electric board are not illustrated for ease of understanding.

As illustrated in FIG. 8, the upper surface of one ejection port forming member 801 (the surface facing in the +Z direction in FIG. 8) is bonded to the lower surface of one print element board 701 (the surface facing in the −Z direction in FIG. 8). In the lower surface of the ejection port forming member 801 (the surface facing in the −Z direction in FIG. 8), each ejection port array 802 is formed with multiple ejection ports arrayed along the longitudinal direction (the Y direction). In the present example, four ejection port arrays 802 are arranged in a width direction (the X direction) of the ejection port forming member 801.

Among the four ejection port arrays 802, tow ejection port arrays 802 adjacent to each other in the width direction (the X direction) eject the same color ink. In the present example, two color inks are ejected from one ejection port forming member 801. Accordingly, use of the two ejection port forming members 801 and the two print element boards 701 makes it possible to eject the aforementioned four color inks.

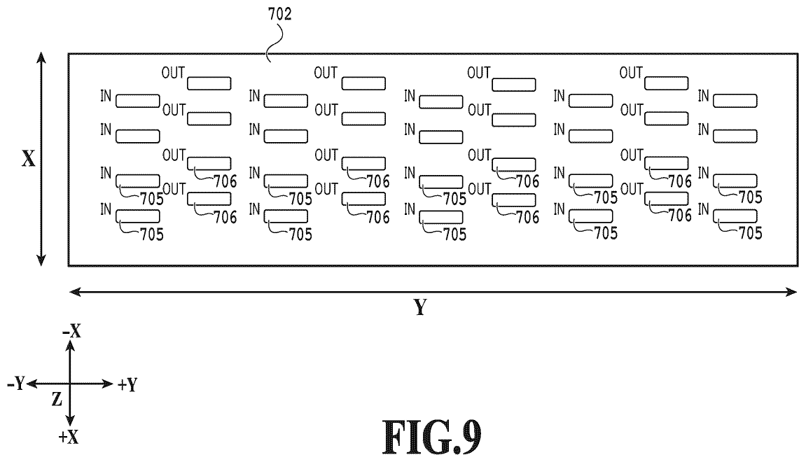

FIG. 9 is a schematic plan view of the aperture plate 702 in the present embodiment.

As illustrated in FIG. 9, the aperture plate 702 includes the multiple plate supply ports 705 and the multiple plate collection ports 706. The apertures marked with “IN” in FIG. 9 are the plate supply ports 705. Meanwhile, the apertures marked with “OUT” are the plate collection ports 706. Through one aperture plate 702, two color inks among the aforementioned four color inks are supplied and collected. In the present example, five plate supply ports 705 arranged along the longitudinal direction (the Y direction) of the aperture plate 702 are connected to one of the common supply channels. Four plate collection ports 706 arranged along the longitudinal direction (the Y direction) of the aperture plate 702 are connected to one of the common collection channels.

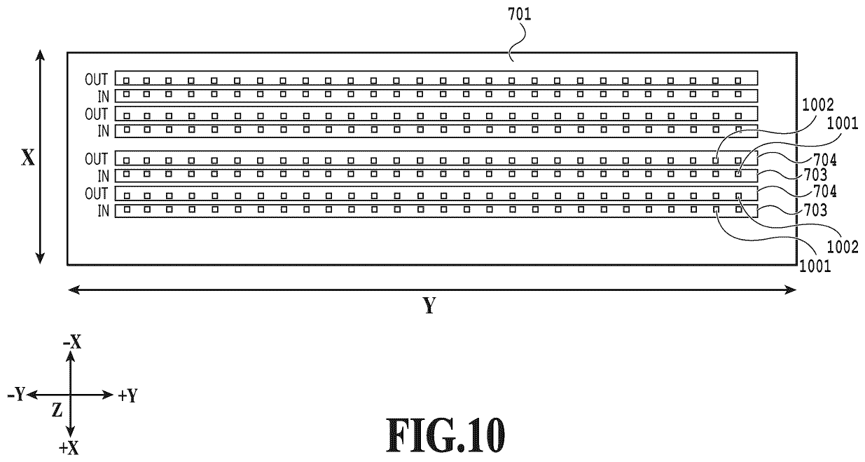

FIG. 10 is a schematic plan view of the print element board 701 in the present embodiment. In FIG. 10, channels marked with “IN” are the common supply channels 703. Meanwhile, the channels marked with “OUT” are the common collection channels 704.

As illustrated in FIG. 10, four common supply channels 703 and four common collection channels 704 are formed on the upper surface of one print element board 701. The four common supply channels 703 and the four common collection channels 704 do not pass through the one print element board 701 in the gravitational direction (the Z direction). In the lower surface of one common supply channel 703, multiple supply ports 1001 are arranged along the longitudinal direction (the Y direction) of the print element board 701.

Each supply port 1001 is formed to extend from the bottom of the common supply channel 703 through the print element board 701 to the lower surface thereof. In the lower surface of one common collection channel 704, multiple collection ports 1002 are arranged along the longitudinal direction (the Y direction) of the print element board 701. Each collection port 1002 is formed to extend from the bottom of the common collection channel 704 through the print element board 701 to the lower surface thereof.

The numbers of the common supply channels 703 and the common collection channels 704 formed are equal to the number of the ejection port arrays. As described above, one ejection port forming member 801 is joined to one print element board 701, and four ejection port arrays 802 are formed in one ejection port forming member 801 (see FIG. 8). Thus, in the present example, four common supply channels 703 and four common collection channels 704 are formed in one print element board 701. The number of the supply ports 1001 formed in one common supply channel 703 is equal to the number of the ejection ports included in one ejection port array 802 (see FIG. 8). The number of the collection ports 1002 formed in one common collection channel 704 is equal to the number of the ejection ports included in one ejection port array 802 (see FIG. 8). The common supply channels 703, the common collection channels 704, the supply ports 1001, and the collection ports 1002 are formed by a photolithography technique.

Here, the two collection ports 1002 at both ends in the longitudinal direction (the Y direction) are located outside both ends of the ejection port array 802 in the longitudinal direction (the Y direction). Then, as illustrated in FIG. 10, both ends of the common collection channel 704 in the longitudinal direction (the Y direction) are located outside the two collection ports 1002 at both ends in the longitudinal direction (the Y direction). In this way, in the present embodiment, the two collection ports 1002 at both ends in the longitudinal direction (the Y direction) are arranged at such positions that the common collection channel 704 may not become a dead end. Such a structure of the collection channel is very effective for a serial-scan type of liquid ejection head.

### <Ink Flow in Ejection Module Unit 202>

FIG. 11 is a schematic cross-sectional view of the ejection module unit 202 cut along the X direction and viewed from the Y direction. In FIG. 11, the ejection module unit 202 is cut at a cutting line passing through a region where the plate supply ports 705 are formed. In FIGS. 11 to 13, a structure of one type of channels for a flow of one color ink among the aforementioned four colors inks will be described as an example for convenience of description. The structures of the four types of channels for flows of the aforementioned respective four color inks are the same except for the colors of the inks in the flows.

As illustrated in FIG. 11, the ejection port forming member 801 includes ejection ports 1101 for ejecting the ink and the pressure chambers 606 formed continuously from the ejection ports 1101. The pressure chambers 606 and the ejection ports 1101 are formed by the photolithography technique.

Each print element board 701 includes multiple heater resistor elements 1102 as energy generator elements capable of generating energy to be used for ink ejection. The heater resistor elements 1102 are arranged at positions corresponding to positions where the respective pressure chambers 606 are formed.

Each print element board 701 includes multiple temperature adjustment mechanisms 1103 each including a heater element in which a conductor layer for use as logic wiring or heater wiring is shaped to have a high resistance. A driver (not illustrated) for driving the above heater element by giving thermal energy thereto and a temperature sensor (not illustrated) for detecting the temperature of the ink are arranged near each temperature adjustment mechanism 1103. The temperature adjustment mechanism 1103 is capable of adjusting the temperature of the ink to a desired temperature by heating the ink at a heating value that varies depending on a difference between the temperature detected by the temperature sensor and the desired target temperature (for example, 40° C.).

The upper surface of the ejection port forming member 801 (the surface facing in the +Z direction in FIG. 11) is bonded to the lower surface of the print element board 701 (the surface facing in the −Z direction in FIG. 11) so that one pressure chamber 606 is coupled to one supply port 1001 and one collection port 1002. The upper surface of the print element board 701 is bonded to the lower surface of the aperture plate 702 so that one common supply channel 703 is coupled to one plate supply port 705. The upper surface of the aperture plate 702 is bonded to the lower surface of the support member 206 so that two plate supply ports 705 are coupled to one support member supply port 707.

With the ejection port forming member 801, the print element board 701, the aperture plate 702, and the support member 206 joined in this way, channels continuous from the support member supply ports 707 to the ejection ports 1101 are formed in the ejection module unit 202. Thus, in the ejection module unit 202, in the course of ink supply, flows of each color ink among the aforementioned four color inks are generated in the forward direction from the support member supply ports 707 through the plate supply ports 705, the common supply channels 703, and the supply ports 1001 to the pressure chambers 606. After that, with application of the energy to the ink filled in each pressure chamber 606 by the heater resistor element 1102, the ink is ejected from the ejection port 1101.

Thus, the present embodiment employs, as an energy generator element, the heater resistor element capable of generating heat and thereby causing film boiling in a liquid. Instead, the technique of the present disclosure is also applicable to a piezoelectric type of liquid ejection head and other various types of liquid ejection heads.

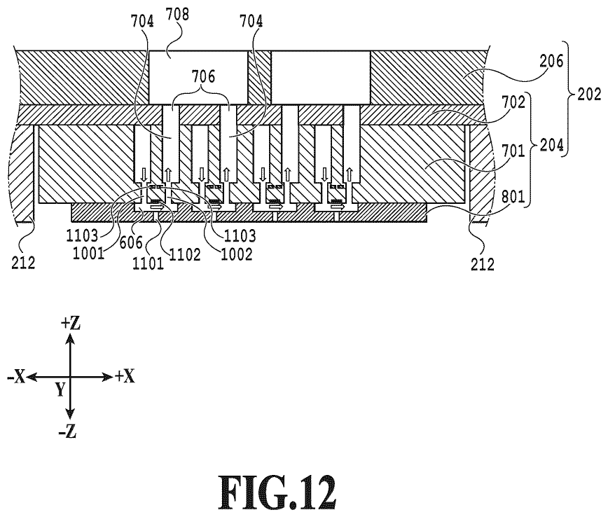

FIG. 12 is a cross-sectional view of the ejection module unit 202 cut in the X direction and viewed from the Y direction. In FIG. 12, the ejection module unit 202 is cut at a cutting line passing through a region where the plate collection ports 706 are formed.

As illustrated in FIG. 12, the upper surface of the print element board 701 is bonded to the lower surface of the aperture plate 702 so that one common collection channel 704 is coupled to one plate collection port 706. The upper surface of the aperture plate 702 is bonded to the lower surface of the support member 206 so that two plate collection ports 706 are coupled to one support member collection port 708. With the ejection port forming member 801, the print element board 701, the aperture plate 702, and the support member 206 joined in this way, channels continuous from the ejection ports 1101 to the support member collection ports 708 are formed in the ejection module unit 202.

Thus, in the course of collecting two color inks in one ejection module unit 202, ink flows for each ink color are generated from the pressure chambers 606 through the collection ports 1002, the common collection channels 704, and the plate collection ports 706 to the support member collection ports 708. Then, the ink is returned from the support member collection ports 708 to the circulation unit through the channel formed in the bottom portion of the casing.

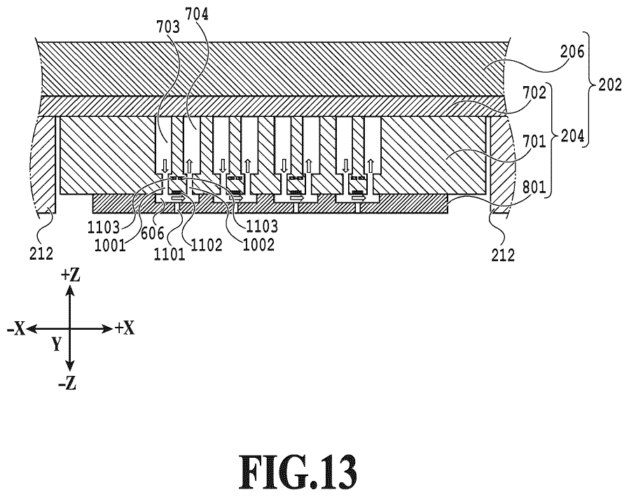

FIG. 13 is a cross-sectional view of the ejection module unit 202 cut in the X direction and viewed from the Y direction. In FIG. 13, the ejection module unit 202 is cut at a cutting line passing through a region where none of the plate supply ports and the plate collection ports are formed.

As illustrated in FIG. 13, the ejection module unit 202 has a region where no apertures are formed in both the aperture plate 702 and the support member 206. The region where none of the plate supply ports and the plate collection ports are formed is used as surfaces for bonding the aperture plate 702 and the support member 206. For this purpose, in this region, none of the support member supply ports and the support member collection ports are formed.

In addition, this region also serves as a region partitioning the support member supply ports and the support member collection ports. In this region, in the course of ink supply, the ink flows in the gravitational direction (the −Z direction) are blocked once by the support member 206. Therefore, in this region, the ink flows along the Y direction through channels formed in the bottom portion of the casing. Then, at the position where the ink reaches the support member supply ports, the ink flows described with FIG. 11 are generated.

On the other hand, in this region, in the course of ink collection, the ink flows in the direction (the +Z direction) opposite to the gravitational direction are blocked once by the aperture plate 702. Therefore, in this region, the ink flows along the common collection channels 704. Then, at the positions where the ink reaches the plate collection ports, the ink flows described with FIG. 12 are generated. The above describes the precise ink flows in this region.

Under the above conditions, the temperature adjustment mechanisms 1103 are arranged along the channels formed in the print element board 701 in the present embodiment. In the present example, the temperature adjustment mechanisms 1103 extend over the entire region in the longitudinal direction of the print element board 701. Instead, the temperature adjustment mechanisms 1103 may partially or discontinuously extend along the longitudinal direction of the print element board 701.

With this structure, the ink flowing inside the print element board 701 is heated by the temperature adjustment mechanisms 1103, so that the temperature of the ink can be adjusted to the desired target temperature. In the present example, the temperature adjustment mechanisms 1103 are arranged in the print element board 701. Instead, the position where the temperature adjustment mechanisms 1103 are arranged is not limited to the print element board 701 as long as the ink can be adjusted to the desired target temperature and ejected. The temperature adjustment mechanisms 1103 may be arranged at any position in the liquid circulation path or may be arranged outside the liquid ejection head. For example, the temperature adjustment mechanisms 1103 may be arranged in the ejection port forming members 801, the aperture plates 702, the support member 206, the pump outlet channel 612 (see FIG. 6), or the first collection channel 607 (see FIG. 6).

### <Keeping of Target Temperature>

Even if the temperature of the ink is adjusted to the temperature suitable for ejection, a decrease in the temperature due to dissipation of the heat during the printing operation may affect the ejection characteristics of the liquid ejection head. To address this, in the present embodiment, the support member 206 is made of a material having a relatively low thermal conductivity. Specifically, the support member 206 is made of a material having a thermal conductivity of 1.0 (W/m·K) or lower (for example, such as resin).

With this structure, the thermal insulation can be improved as compared with a support member made of a material having a high thermal conductivity (for example, ceramics such as alumina). The use of a material having a relatively low thermal conductivity to fabricate the support member 206 makes it possible to easily keep the adjusted temperature. In sum, according to the liquid ejection head in the present embodiment, with such a simple structure, it is possible to keep a desired temperature of the liquid after the liquid is adjusted to the desired temperature.

In addition, with the objective of keeping the temperature of the ink flowing inside the ejection module 204, it is more preferable that the thickness (a length in the Z direction) of the support member 206 be 2 mm or more. With this structure, even if the casing is made of a material having a relatively high thermal conductivity (for example, such as a metal), the amount of heat dissipating from the ejection module 204 to the casing via the support member 206 can be reduced. As a result, the time and power necessary to increase the temperature of the ink to the desired temperature can be reduced.

In addition, with the objective of keeping the adjusted temperature of the ink, it is desirable that the surface of the support member 206 facing in the direction in which the support member 206 is bonded to the ejection module 204 (the surface facing in the −Z direction) have a large area. For example, the lower surface of the support member 206 (the surface facing in the −Z direction) preferably has an area of 1500 mm² or larger. With this structure, the thermal resistance of the support member 206 can be made relatively high. This makes it easier to keep the temperature of the ink flowing inside the ejection module 204. Moreover, the time and power necessary to increase the temperature of the ink to the desired temperature can be reduced.

In addition, the lower the flow rate of the ink flowing inside the support member 206, the better. For example, the flow rate of the ink flowing inside the support member 206 is preferably 10 mL/sec or lower. With this structure, the volume of the support member 206 per unit amount of the ink becomes greater. This makes it easier to keep the temperature of the ink flowing inside the support member 206. Moreover, the time and power necessary to increase the temperature of the ink to the desired temperature can be reduced.

Further, the face cover 212 is also preferably made of a material having a relatively low thermal conductivity. Specifically, the face cover 212 is preferably made of a material having a thermal conductivity of 1.0 (W/m·K) or lower (for example, such as resin). The temperature keeping effect in the liquid ejection head is improved more as the total volume of the materials having the relatively low thermal conductivity becomes greater. Therefore, if the face cover 212 is also made of a material having a relatively low thermal conductivity, the liquid ejection head 102 can exert the temperature keeping effect more favorably.

According to this structure, the temperature keeping effect of the liquid ejection head including the face cover 212 made of a material having a relatively low thermal conductivity is higher than that of a liquid ejection head including a face cover made of a material having a relatively high thermal conductivity. For example, the temperature keeping effect of a liquid ejection head including a resin face cover 212 is higher than that of a liquid ejection head including an alumina face cover.

In addition, the temperature keeping effect of the liquid ejection head including the face cover 212 made of the material having the relatively low thermal conductivity is higher than that of a liquid ejection head not including any face cover. As a result, the time and power necessary to increase the temperature of the ink to the desired temperature can be also reduced. However, it is not essential to make the face cover 212 using a material having a relatively low thermal conductivity. The effect of the present embodiment can be obtained only if the support member 206 is made of a material having a relatively low thermal conductivity.

### Other Embodiments

With the objective of minimizing the amount of heat dissipating from the ejection module 204 into the air, it is desirable that the surface of the ejection module 204 facing in the direction in which the ejection module 204 is bonded to the support member 206 (the surface facing in the +Z direction) have a small area. For example, the upper surface of the ejection module 204 (the surface facing in the +Z direction) more preferably has an area of 400 mm² or smaller.

With this structure, the surface area of the ejection module 204 can be reduced. To reduce the surface area of the ejection module 204 as much as possible makes it easier to keep the adjusted temperature. Moreover, the time and power necessary to increase the temperature of the ink to the desired temperature can be also reduced.

Meanwhile, the operation of a serial type of liquid ejection head is stopped once between a time point at which the scanning in the forward path ends and a time point at which the scanning in the return path starts. Therefore, in the serial type of liquid ejection head, the temperature of the ejection module 204 tends to decrease while the scanning is stopped, as compared with a line-type liquid ejection head. Therefore, the serial type of liquid ejection head including the support member 206 can exert the temperature keeping effect more favorably than the line type of liquid ejection head including the support member 206.

The example in FIG. 1 illustrates the serial type of liquid ejection head, but the technique of the present disclosure is applicable to full-multi types of liquid ejection heads and other types of liquid ejection heads.

According to the liquid ejection head in the present disclosure, with such a simple structure, it is possible to keep a desired temperature of the liquid after the liquid is adjusted to the desired temperature.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-078597, filed May 11, 2023, which is hereby incorporated by reference wherein in its entirety.

What is claimed is:

1. A liquid ejection head comprising:
an ejection module including:
an ejection port capable of ejecting a liquid,
a pressure chamber capable of storing the liquid to be ejected from the ejection port,
a supply channel configured to supply the liquid to the pressure chamber,
an energy generator element capable of generating energy for ejecting the liquid stored in the pressure chamber, and
a collection channel configured to collect, to the pressure chamber, the liquid not ejected from the ejection port; and
a support member joined to the ejection module and configured to support the ejection module, wherein
the liquid flowing in the pressure chamber, the supply channel, and the collection channel is adjusted to a predetermined temperature by a temperature adjustment mechanism, and
a material for making the support member has a thermal conductivity of 1.0 (W/m·K) or lower.

2. The liquid ejection head according to claim 1, wherein the material for making the support member is resin.

3. The liquid ejection head according to claim 1, wherein a thickness of the support member in a direction in which the support member is joined to the ejection module is 2 mm or more.

4. The liquid ejection head according to claim 1, wherein the support member supports a plurality of the ejection modules.

5. The liquid ejection head according to claim 1, wherein a surface of the support member facing in a direction in which the support member is joined to the ejection module has an area of 1500 mm² or larger.

6. The liquid ejection head according to claim 1, wherein a flow rate of the liquid flowing inside the support member is 10 mL/sec or lower.

7. The liquid ejection head according to claim 1, wherein a surface of the ejection module facing in a direction in which the ejection module is joined to the support member has an area of 400 mm² or smaller.

8. The liquid ejection head according to claim 1, further comprising a face cover configured to cover a surface of the liquid ejection head on which the ejection module is arranged while exposing the ejection module, wherein
a material for making the face cover has a thermal conductivity of 1.0 (W/m·K) or lower.

9. The liquid ejection head according to claim 1, wherein the predetermined temperature is 40° C.

10. The liquid ejection head according to claim 1, further comprising the temperature adjustment mechanism, wherein
the temperature adjustment mechanism is arranged along the channels formed in the ejection module.

11. The liquid ejection head according to claim 10, wherein the temperature adjustment mechanism includes a heater element, a temperature sensor configured to detect the temperature of the liquid, and a driver configured to drive the heater element.

12. The liquid ejection head according to claim 1, further comprising a circulator pump capable of generating a flow to supply the liquid to the supply channel and a flow to collect the liquid from the collection channel.

13. The liquid ejection head according to claim 1, wherein
the ejection module includes
a first circulation path for a first color ink, the first circulation path including the pressure chamber, the supply channel, and the collection channel, and
a second circulation path for a second color ink different in color from the first color ink, the second circulation path including the pressure chamber, the supply channel, and the collection channel.

14. The liquid ejection head according to claim 1, wherein the energy generator element is a heater resistor element capable of generating heat to cause film boiling in the liquid.

15. A liquid ejection apparatus comprising:
a liquid ejection head;
a carriage configured to move the liquid ejection head in a main-scanning direction with the liquid ejection head mounted on the carriage; and
a conveyance unit configured to convey a printing medium in a conveyance direction crossing the main-scanning direction,
wherein the liquid ejection head includes
an ejection module including
an ejection port capable of ejecting a liquid,
a pressure chamber capable of storing the liquid to be ejected from the ejection port,
a supply channel configured to supply the liquid to the pressure chamber,
an energy generator element capable of generating energy for ejecting the liquid stored in the pressure chamber, and
a collection channel configured to collect, to the pressure chamber, the liquid not ejected from the ejection port; and
a support member joined to the ejection module and configured to support the ejection module,
the liquid flowing in the pressure chamber, the supply channel, and the collection channel is adjusted to a predetermined temperature by a temperature adjustment mechanism, and
a material for making the support member has a thermal conductivity of 1.0 (W/m·K) or lower.
